(19) United States
(12) Patent Application Publication
(10) Pub. No.: US 2019/0016195 A1
(43) Pub. Date: Jan. 17, 2019

(54) BATTERY OPERATED AIR CONTROLLER SYSTEM IN MOTOR VEHICLES

(71) Applicant: Minnie Stinson, Homewood, IL (US)

(72) Inventor: Minnie Stinson, Homewood, IL (US)

(21) Appl. No.: 15/646,186

(22) Filed: Jul. 11, 2017

(51) Int. Cl. B60H 1/24

(52) U.S. Cl. CPC B60H 1/24

(57) ABSTRACT

The invention is one or more battery operated air controller systems integrated in motor vehicles to generate air flow. It includes a sensor car key pad. The air controller system is separate from the engine's based heating and cooling system. It is an independent system.

### BACKGROUND OF THE INVENTION

This invention relates to having one or more battery operated air controller systems integrated in motor vehicles. The battery operated air controller system includes a sensor car key pad to turn the system on or off while you are outside of the motor vehicle. The battery operated air controller system provides air to flow throughout the motor vehicle. You can turn the battery operated air controller on or off, either while you are inside or outside the motor vehicle. There exists a need for a battery operated air controller system in motor vehicles to access when the engine's based heating/cooling system malfunctions and/or requires repairs. The system is to generate air flow while the engine is off and to access either while you are inside or outside the motor vehicle. The system is separate from the engine based heating and cooling system.

### DETAILED DESCRIPTION OF INVENTION

You have an option to turn the system on or off while inside the motor vehicle, or while you are outside of the motor vehicle. The sensor car key pad is an assessment which allows you to turn the switch on or off while you are outside the motor vehicle. This assessment allows you to maintain the flow of air prior to getting inside the motor vehicle.

Alkaline batteries provide enough power to make way of portable devices. Lithium batteries have a long lasting power for high tech devices. Batteries can be purchased in different sizes, power, and they are cost efficient. The battery operated air controller system saves energy, helps to keep the air flowing either while you are inside or outside the motor vehicle, and helps to avoid carbon monoxide poisoning because its battery operated, and its low maintenance.

### BRIEF DESCRIPTION OF THE DRAWINGS

FIG. 1 is a diagram of the ventilated housing unit (1), a switch to turn the system on or off (2), a handle, knob or button that opens and closes the housing unit (3), and a compartment to store the battery (4).

FIG. 2 is a diagram of fan blades (5). The fan blades are to be integrated in the ventilated housing unit.

FIG. 3 is a diagram of the battery operated air controller system in its entirety. The ventilated housing unit that houses the fan blades, a handle, knob or button to open and close the ventilated housing unit, and a switch to turn the air controller on or off.

FIG. 4 is a diagram of the sensor car key pad (6), a switch (7), and a compartment to store the battery (8).

### DETAILED DESCRIPTION OF THE DRAWINGS

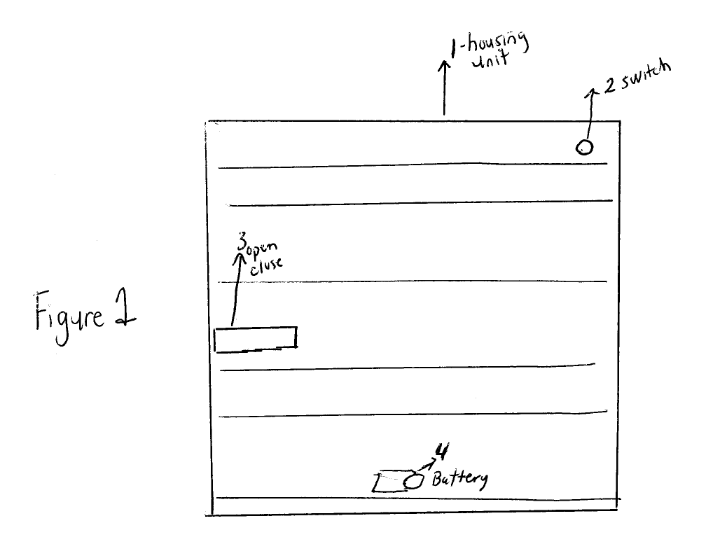

FIG. 1 is the ventilated housing unit (1). The battery is preferably located within the housing unit (4). The housing unit may include multiple components. The housing unit will either have a handle, knob or button to open or close the unit (3). The ventilated housing unit is to allow the air to pass out of the unit. There's also a switch that will turn the system off or on (2). The battery may be rechargeable or a one-time use battery. In an embodiment where the battery is rechargeable, the battery may be removable from the housing unit for recharging or the housing unit may connect to a charging source that charges the battery. The battery may include a button cell battery or any other battery of a suitable size to fit into the housing unit.

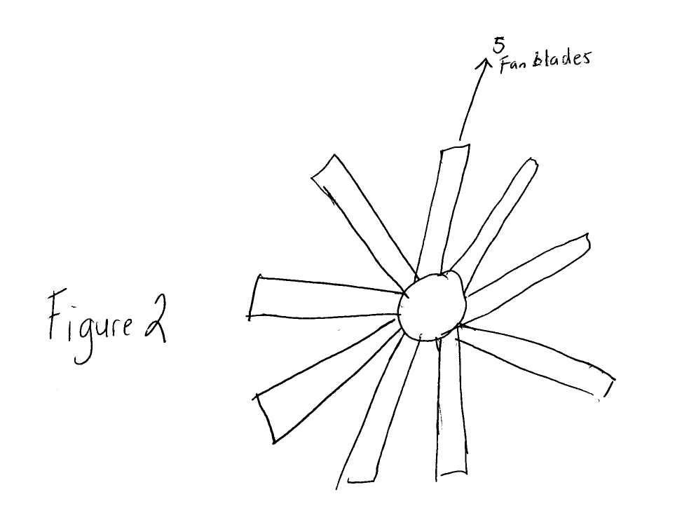

FIG. 2 is the fan blades which will be integrated in the housing unit (5). Six or more fan blades will be integrated, but not limited. The rotating assembly of blades generates the air flow.

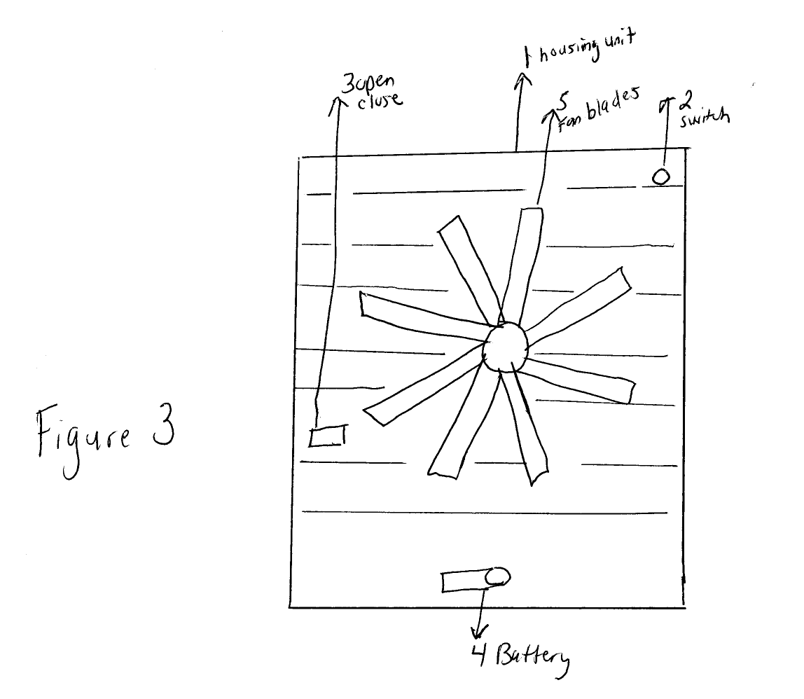

FIG. 3 are diagrams of FIGS. 1 and 2. The diagram is the air controller system in its entirety. The size of the system will vary from 6¼ inches, height, 11½ inches, width, rounded 4 inches, depth, and the fan diameter 5½ inches, but not limited to this specific measurement. The size will be determined by the number of systems integrated in the motor vehicle.

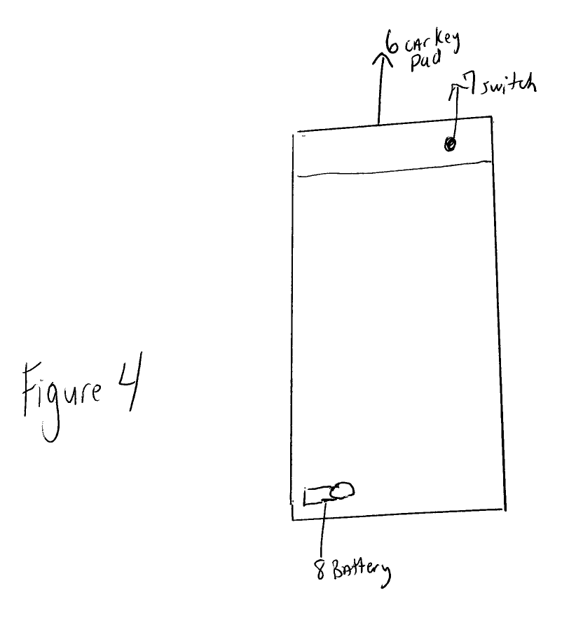

FIG. 4 is a diagram of the sensor car key pad (6), switch (7) and compartment to store the battery (8). It's an assessment that allows you to turn the system on or off while you are outside the motor vehicle (7). It will include either a button cell battery or any other battery of a suitable size to fit into the battery compartment.

What is claimed is:

1. A battery operated air controller system comprising:
a ventilated housing unit, the ventilated housing unit comprising of fan blades, either a handle, button, or knob to open or close the ventilated housing unit, a compartment for the battery, and a switch to turn the system on or off.
a sensor car key pad, with a compartment for the battery, and a switch.
